(19) United States
(12) Patent Application Publication
(10) Pub. No.: US 2008/0170668 A1
(43) Pub. Date: Jul. 17, 2008

(54) MICRO X-RAY SOURCE

(75) Inventors: Pieter Kruit, Delft (NL); Cornelis Wouter Hagen, Delft (NL); Elvira Hendrika Mulder, Pijnacker (NL)

Correspondence Address: PEACOCK MYERS, P.C., 201 THIRD STREET, N.W., SUITE 1340, ALBUQUERQUE, NM, 87102, US

(73) Assignee: Technische Universiteit Delft, Delft (NL)

(21) Appl. No.: 11/851,729

(22) Filed: Sep. 7, 2007

Related U.S. Application Data
(63) Continuation of application No. PCT/NL2006/000118, filed on Mar. 8, 2006.

(30) Foreign Application Priority Data
Mar. 8, 2005 (NL) 1028481

(51) Int. Cl. H01J 35/12; H01J 9/18

(52) U.S. Cl. 378/141; 445/49

(57) ABSTRACT

A micro X-ray source comprising a target acting as anode, and a cathode, which during operation interacts with the target and functions as electron source, wherein the target is embodied as a metal foil possessing a spot where the electrons from the electron source arrive, and the metal foil being locally thinner at the spot.

### CROSS-REFERENCE TO RELATED APPLICATIONS

This application is a continuation-in-part application of Patent Cooperation Treaty Patent Application Serial No. PCT/NL2006/000118, entitled “Micro X-Ray Source”, to Technische Universiteit Delft from Pieter Kruit, Cornelis W. Hagen and Elvira H. Mulder, filed on Mar. 8, 2006, and the specification and claims thereof are incorporated herein by reference.

This application claims priority to and the benefit of the filing of Netherlands Patent Application Serial No. 1028481, entitled “Microröntgenbron” (Micro X-Ray Source), filed on Mar. 8, 2005, and the specification and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

COPYRIGHTED MATERIAL

Not Applicable.

### BACKGROUND OF THE INVENTION

1. Field of the Invention (Technical Field)

The present invention relates to a micro X-ray source comprising a target acting as anode, and a cathode, which during operation interacts with the target and functions as electron source, wherein the target is embodied as a metal foil possessing a spot where the electrons from the electron source arrive.

2. Description of Related Art

Such a micro X-ray source is known from practice and distinguishes itself from conventional micro X-ray sources by the size of the spot, which measures approximately 1 μm.

Such micro X-ray sources are applied in those areas where a high resolution is important, for example for carrying out inspections and controls in the micro-electronics production, material-stress studies, (DNA) structure studies, computer tomography and geophysical studies, Other applications are not excluded.

With respect to the known micro X-ray source, the target is used in combination with heat dissipation means in the form of a substrate onto which the material of the target is applied. However, this is disadvantageous, as apart from the intended X-rays emitted by the target such a substrate produces X-rays as well, which lowers the quality of the X-ray source and the resolution to be achieved therewith.

### BRIEF SUMMARY OF THE INVENTION

It is an object of the invention to improve the micro X-ray source such as to achieve a higher resolution, without concessions with respect to the power of the micro X-ray source.

To this end the micro X-ray source according to the invention is characterized in that the metal foil is thinner at the spot.

Making only the spot area thinner, provides a very concentrated region where the X-rays are generated. This effectively restricts the divergence of these X-rays and thus improves the resolution that can be attained with the micro X-ray source according to the invention. It should be noted that the spot may be circular, but may also take the form of a slot. In the latter case, the electron beam may be able to move to and fro at the slot.

In order to further advance the prospect of achieving the object of the invention, it is desirable that a path described by electrons originating at the cathode and directed at the target, be free from heat dissipation means.

In order to nonetheless provide adequate heat dissipation, it is desirable that the target be provided with heat dissipation means in the form of a thickening immediately adjacent to and in a first vicinity of the spot, which becomes thicker with increasing distance from the thinner portion.

With respect to effective heat dissipation, it suffices for the increasing thickness to extend only to a second vicinity directly adjacent to the first vicinity, and that in said second vicinity the target has a substantially uniform thickness. This uniform thickness is, for example, at least twice the thickness of the thinner portion.

The micro X-ray source according to the invention is suitably embodied such that the thickness of the thinner portion is at most approximately 2.5 μm, using a 100 kV-electron source. With this a micro X-ray source can be realized whose X-ray beam has a diameter of approximately 1 μm.

The micro X-ray source is preferably realized such that the target seals a vacuum space.

The invention is also embodied in a method for the fabrication of a target suitable for use in a micro X-ray source. According to the invention, this method is characterized by the composition of a plate comprised of different layers of material one on top of the other, wherein a top layer of material reacts faster with an etching agent than the lower layer directly under the top layer of material, and by using said etching agent to locally etch the top layer of material down to the lower layer.

### BRIEF DESCRIPTION OF THE SEVERAL VIEWS OF THE DRAWINGS

The accompanying drawing, which is incorporated into and forms a part of the specification, illustrates one or more embodiments of the present invention and, together with the description, serves to explain the principles of the invention. The drawing is only for the purpose of illustrating one or more preferred embodiments of the invention and is not to be construed as limiting the invention. The invention is further elucidated by way of a non-limiting exemplary embodiment and by way of the drawing. In the drawing:

FIG. 1 shows a schematic illustration of the construction of a micro X-ray source according to the invention.

### DETAILED DESCRIPTION OF THE INVENTION

The invention is further illustrated by the following non-limiting example.

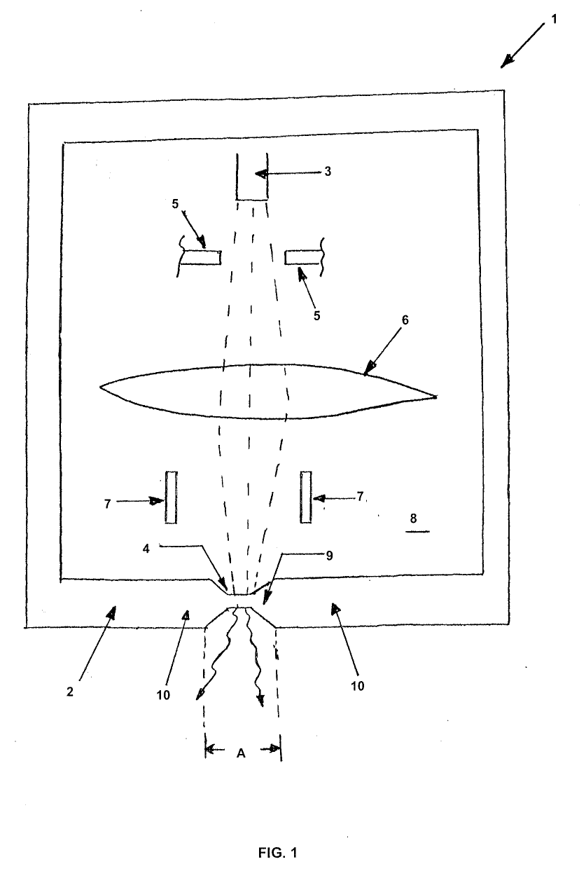

The micro X-ray source 1 shown in the FIG. 1 comprises a target acting as anode 2, as well as a cathode 3 interacting during operation with the target 2 and functioning as electron source.

The target 2 is embodied in the form of a metal foil. A suitable material is, for example, tungsten, iridium or osmium.

The target 2 further possesses a spot 4 where the electrons from the electron source 3 collide with the material of the target 2.

The FIGURE further shows that in the direction of the electron beam directed at the target 2, the micro X-ray source 1 may be provided with an extractor 5, a lens 6 and deflector plates 7. The person skilled in the art is acquainted with the function and working of these components and a further explanation is not needed.

The FIGURE clearly shows that the metal foil of the target 2 is locally thinner at the spot 4.

The person skilled in the art further appreciates from the FIGURE that the target 2 is provided with heat dissipation means in the form of a thickening 9, immediately adjacent to and in a first vicinity A of the thinner portion of the spot 4 and becoming thicker with increasing distance from the thinner portion of the spot 4.

In a second vicinity 10 directly adjacent to the first vicinity A, the target 2 has a substantially uniform thickness of, for example, 100 μm.

At the spot 4, the target 2 has a thinner portion where the thickness is at most approximately 2.5 μm.

The FIGURE further shows that the target 2 is free from heat dissipation means located in the path of the electron beam between cathode 3 and spot 4.

In a practical embodiment, the radius of the spot 4 may be approximately 2.5 μm, wherein the spot on a tungsten foil is able to reach a temperature of 1900 K, the thickness of the spot 4 locally being approximately 2.4 μm.

The FIGURE further shows that the target 2 seals a vacuum space 87 in which the cathode 3, extractor 5, lens 6 and deflector plates 7 are disposed.

Finally, the invention is embodied in a method of fabricating a target 2.

In accordance with one aspect of the invention, this target 2 is fabricated by composing a plate from different layers of material one on top of the other, wherein a top layer of material reacts faster with an etching agent than the lower layer directly underneath the top layer of material, and by using said etching agent to locally etch the top layer of material down to the lower layer.

The plate from which the target is formed may, for example, be obtained by vapor-depositing a layer of tungsten on a copper plate, and optionally applying a sealing layer of copper on the free side of the tungsten layer. The latter may be done by electroplating. To form the spot, the copper upper layer may subsequently be etched using a suitable etching agent. The fact that the copper material permanently surrounding the spot forms an excellent heat conductor, is well known. Instead of copper it is also possible to use diamond.

What is claimed is:

1. A micro X-ray source comprising a target acting as anode, and a cathode, which during operation interacts with the target and functions as electron source, wherein the target is embodied by a metal foil possessing a spot where the electrons from the electron source arrive, and wherein the metal foil is locally thinner at the spot.

2. A micro X-ray source according to claim 1, wherein the target is provided with heat dissipation means in the form of a thickening immediately adjacent to and in a first vicinity of the spot, which becomes thicker with increasing distance from the thinner portion.

3. A micro X-ray source according to claim 2, wherein the target in a second vicinity directly adjacent to the first vicinity, has a substantially uniform thickness.

4. A micro X-ray source according to claim 1, wherein the thickness of the thinner portion is at most 2.5 μm, when using a 100 kV-electron source.

5. A micro X-ray source according to claim 1, wherein a path described by electrons originating at the cathode and directed at the target, is free from heat dissipation means.

6. A micro X-ray source according to claim 1, wherein the target seals a vacuum space.

7. A method for the fabrication of a target suitable for use in a micro X-ray source comprising providing a plate comprised of different layers of material one on top of the other, wherein a top layer of material reacts faster with an etching agent than the lower layer directly under the top layer of material, and using said etching agent to locally etch the top layer of material down to the lower layer.
